(19) United States
(12) Patent Application Publication
(10) Pub. No.: US 2019/0094749 A1
(43) Pub. Date: Mar. 28, 2019

(54) IMAGE FORMING APPARATUS

(71) Applicant: CANON KABUSHIKI KAISHA, Tokyo (JP)

(72) Inventor: Michihiro Yoshida, Nagareyama-shi (JP)

(21) Appl. No.: 16/134,690

(22) Filed: Sep. 18, 2018

(30) Foreign Application Priority Data
Sep. 22, 2017 (JP) 2017-181953
Jul. 17, 2018 (JP) 2018-134290

(51) Int. Cl. G03G 15/08

(52) U.S. Cl. CPC G03G 15/0848; G03G 15/556; G03G 15/0818

(57) ABSTRACT

An image forming apparatus includes a first counting unit counting an entire image ratio, a second counting unit counting a partial image ratio, a display unit displaying information about maintenance of a photoconductor, and an execution unit that performs the display in the display unit so that X when the entire image ratio and the partial image ratio have first and second values, respectively, is greater than X when the entire image ratio and the partial image ratio have values smaller than the first and second values, respectively, and X when the partial image ratio and the entire image ratio have third and fourth values, respectively, is smaller than X when the partial image ratio and the entire image ratio have values smaller than the third and fourth values, respectively. X denotes the number of repeated image formations with the fixed entire and partial image ratios.

### BACKGROUND

### Field of the Disclosure

The present disclosure relates to a copier, a laser printer, a facsimile machine, a printing apparatus, or an electrophotographic image forming apparatus applied to the copier and so on.

### Description of the Related Art

Image forming apparatuses performing an image forming operation are in widespread use. In the image forming operation, a photoconductor is charged with a charging unit, an electrostatic image formed on the photoconductor using an exposure unit is subjected to reversal development with a development unit to form a toner image, and the toner image is transferred to a recording material using another rotating member (an intermediate transfer member or a recording material feeding member) for heat fixing. The image forming apparatuses have a problem of fusion bonding of toner, in which a toner-derived component adheres to the surface of a photoconductor drum due to discharge to cause a poor image.

In contrast, in Japanese Patent Laid-Open No. 2011-107662, idle rotation is performed for one minute as a refresh mode based on a printing rate used for a predetermined time period to remove toner filming.

However, it has been found that only the removal of the toner filming based on the printing rate, as in Japanese Patent Laid-Open No. 2011-107662, does not lead accurate detection of the fusion bonding of toner. In other words, in the status of an occurrence of the fusion bonding of toner, the fusion bonding of toner is grown at a significantly rapid rate in portions where the amount of consumption of toner from the entire development unit is large and the image ratio in the main scanning direction is low while the fusion bonding of toner is difficult to grow in portions where the amount of consumption of toner from the entire development unit is large and the image ratio in the main scanning direction is high, compared with the above portions.

When accurate detection of the fusion bonding of toner is not realized, the errors in the timing of display of the life and estimation of the life is disadvantageously increased. In addition, a recovery mode to remove the fusion bonding of toner that has grown is frequently performed to reduce the productivity.

Accordingly, there is a need to provide an image forming apparatus capable of accurately detecting the fusion bonding of toner.

### SUMMARY

The present disclosure provides an image forming apparatus including a movable photoconductor; a charging member that charges the photoconductor; an exposure unit that performs image exposure based on an image signal to the charged photoconductor to form an electrostatic latent image; an image forming unit that causes toner to adhere to the electrostatic latent image formed on the photoconductor to form a toner image and, then, transfers the toner image on a recording material to form an image; a counting unit including a first counting unit and a second counting unit, the first counting unit counting an entire image ratio, which is a ratio of an image to the image signal corresponding to one entire image, the second counting unit counting a partial image ratio, which is a ratio of an image to the image signal corresponding to each portion resulting from division of one entire image in a main scanning direction orthogonal to a direction in which the photoconductor moves; a display unit that displays information about maintenance of the photoconductor or information about maintenance of a unit that includes the photoconductor and that is removable from a main body of the image forming apparatus; and an execution unit that performs the display in the display unit based on the entire image ratio and the partial image ratio, which are counted by the counting unit, and that performs the display in the display unit so that (1) X when image formation is repeated in a condition in which the entire image ratio has a first value and the partial image ratio has a second value is greater than X when the image formation is repeated in a condition in which the entire image ratio has a value smaller than the first value and the partial image ratio has a value smaller than the second value and (2) X when image formation is repeated in a condition in which the partial image ratio has a third value and the entire image ratio has a fourth value is smaller than X when the image formation is repeated in a condition in which the partial image ratio has a value smaller than the third value and the entire image ratio has a value smaller than the fourth value, X denoting a number of image formations from a time when use of the photoconductor or the unit is started to a time when the display is performed in the display unit.

The present disclosure provides an image forming apparatus including a movable photoconductor; a charging member that charges the photoconductor; an exposure unit that performs image exposure based on an image signal to the charged photoconductor to form an electrostatic latent image; an image forming unit that causes toner to adhere to the electrostatic latent image formed on the photoconductor to form a toner image and, then, transfers the toner image on a recording material to form an image; a counting unit including a first counting unit and a second counting unit, the first counting unit counting an entire image ratio, which is a ratio of an image to the image signal corresponding to one entire image, the second counting unit counting a partial image ratio, which is a ratio of an image to the image signal corresponding to each portion resulting from division of one entire image in a main scanning direction orthogonal to a direction in which the photoconductor moves; and an execution unit that performs a recovery mode in which a toner image is formed on the photoconductor based on the entire image ratio and the partial image ratio, which are counted by the counting unit, during a period excepting an image formation period to supply toner to a cleaning blade, thus rotating the photoconductor and that performs the recovery mode so that (1) X when image formation is repeated in a condition in which the entire image ratio has a first value and the partial image ratio has a second value is greater than X when the image formation is repeated in a condition in which the entire image ratio has a value smaller than the first value and the partial image ratio has a value smaller than the second value and (2) X when image formation is repeated in a condition in which the partial image ratio has a third value and the entire image ratio has a fourth value is smaller than X when the image formation is repeated in a condition in which the partial image ratio has a value smaller than the third value and the entire image ratio has a value smaller than the fourth value, X denoting a number of image formations from a time when one recovery mode is performed to a time when the next recovery mode is performed.

Further features of the present disclosure will become apparent from the following description of exemplary embodiments with reference to the attached drawings.

### BRIEF DESCRIPTION OF THE DRAWINGS

FIG. 1 is a diagram for describing an exemplary configuration of an image forming apparatus.

FIG. 2 is a diagram for describing an exemplary configuration of an image forming station.

FIG. 3 is a block diagram of detection control according to one or more aspects of the present disclosure.

FIG. 4A and FIG. 4B are diagrams for describing a divided video count used in the control and the kinds of images.

FIG. 5 is a flowchart illustrating a control process of estimating fusion bonding of toner according to one or more aspects of the present disclosure.

FIG. 6 is a graph for describing comparative verification in the first embodiment.

FIG. 7 is a block diagram of recovery mode control according to one or more aspects of the present disclosure.

FIG. 8 is a flowchart illustrating a process of controlling a recovery mode of the fusion bonding of toner.

FIG. 9 is a timing chart illustrating how the recovery mode of the fusion bonding of toner is controlled.

FIG. 10 is a graph for describing comparative verification according to one or more aspects of the present disclosure.

### DESCRIPTION OF THE EMBODIMENTS

Embodiments of the present disclosure will herein be described with reference to the drawings. However, the sizes, the materials, and the shapes of components described in the embodiments and the relative arrangement of these components should be appropriately varied depending on the configuration and various conditions of an apparatus to which the present disclosure is applied. It is not intended to limit the scope of the present disclosure to the embodiments described below.

### First Embodiment

### 1. Description of Schematic Configuration of Image Forming Apparatus

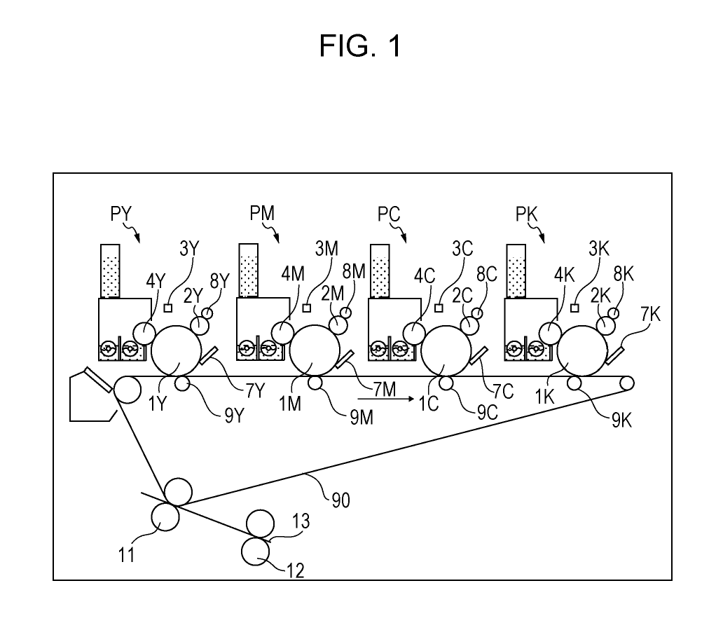

FIG. 1 is a diagram for describing an exemplary configuration of an image forming apparatus according to a first embodiment. Referring to FIG. 1, the image forming apparatus is a full-color printer adopting a tandem intermediate transfer system, in which image forming stations PY, PM, PC, and PK of yellow, magenta, cyan, and black, respectively, are arranged along an intermediate transfer belt 90.

In the image forming station PY, a yellow toner image adheres to an electrostatic latent image formed on a photoconductor drum 1Y to be transferred to the intermediate transfer belt 90. In the image forming station PM, a magenta toner image adheres to an electrostatic latent image formed on a photoconductor drum 1M to be transferred to the intermediate transfer belt 90. In the image forming stations PC and PK, a cyan toner image and a black toner image adhere to electrostatic latent images formed on a photoconductor drum 1C and a photoconductor drum 1K, respectively, to be transferred to the intermediate transfer belt 90.

A full-color toner image formed by superimposing the toner images of the four colors is fed to a secondary transfer unit 11 with the rotation of the intermediate transfer belt 90 to be secondarily transferred to a recording material 13. In other words, each image forming station causes the toner to adhere to the electrostatic latent image formed on the photoconductor drum to form the toner image and, then, transfers the toner image on the recording material to form an image.

The recording material 13 pulled out from a recording material cassette (not illustrated) is separated into each sheet by the secondary transfer unit 11 and is fed to a registration roller 12. The registration roller 12 transfers the recording material 13 to the secondary transfer unit 11 in synchronization with the toner image on the intermediate transfer belt 90. The recording material 13 on which the full-color toner image is secondarily transferred by the secondary transfer unit 11 is subjected to application of heat and pressure in a fixing unit (not illustrated) and an image is fixed on the surface of the recording material 13. Then, the recording material 13 on which the image is fixed is ejected from the apparatus.

The image forming stations PY, PM, PC, and PK have substantially the same configuration except that different colors of toner (developer) are used in development units 4Y, 4M, 4C, and 4K, respectively. The image forming station PY will be described below and the image forming stations PM, PC, and PK are described in a manner in which Y at the end of the reference letters added to the components in the image forming station PY is replaced with M, C, and K, respectively.

### 2. Description of Schematic Configuration of Image Forming Station

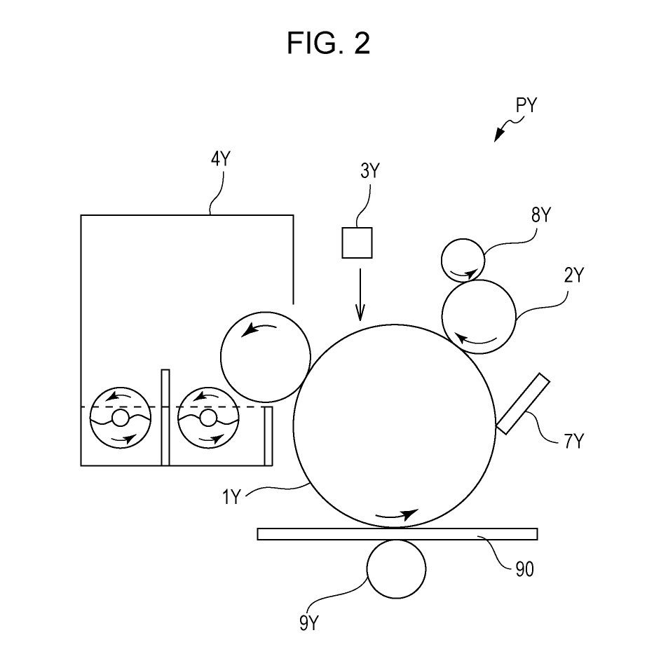

FIG. 2 is a diagram for describing an exemplary configuration of the image forming station PY.

In the image forming station PY, a charging roller (charging member) 2Y and a charging roller cleaning member 8Y are arranged around the rotatable (movable) photoconductor drum (photoconductor) 1Y.

In addition, an exposure unit 3Y, the development unit 4Y, a cleaning blade 7Y, and a primary transfer roller 9Y are arranged around the rotatable (movable) photoconductor drum (photoconductor) 1Y. Voltage is applied to the charging roller (charging member) 2Y to charge the photoconductor drum (photoconductor) 1Y with the voltage.

The exposure unit 3Y performs image exposure based on an image signal to the charged photoconductor drum (photoconductor) 1Y to form an electrostatic latent image.

Although the members including the photoconductor drum compose a unit removable from the main body of the image forming apparatus in the first embodiment, a configuration may be adopted in which only the photoconductor drum is removable from the main body of the image forming apparatus.

### 3. Description of how to Estimate Fusion Bonding of Toner

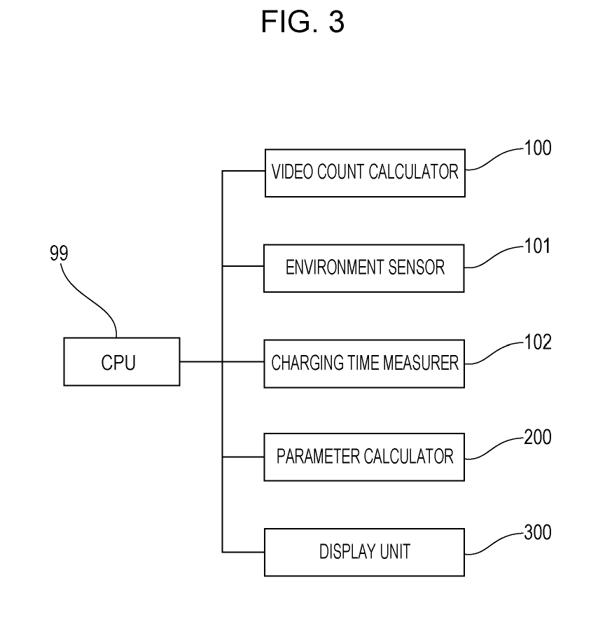

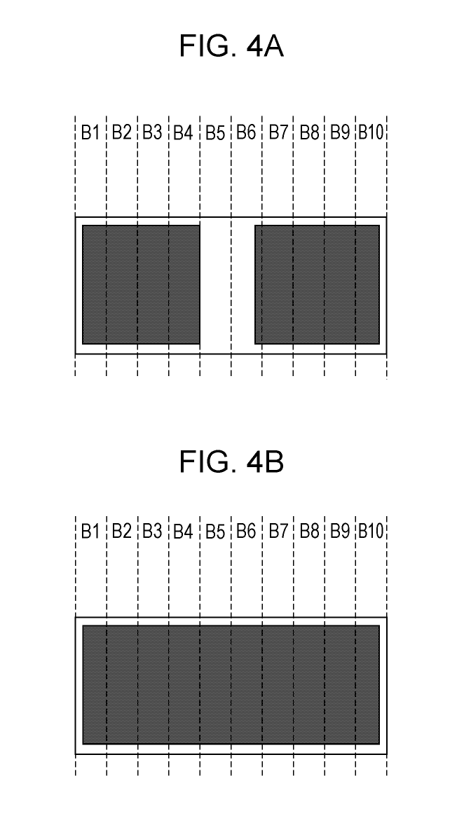

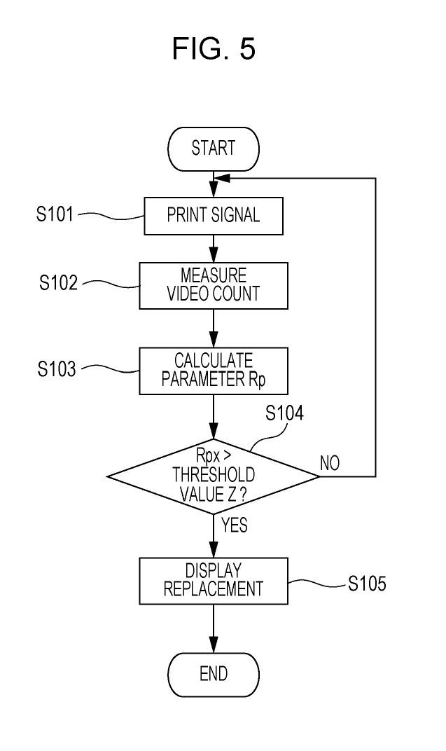

FIG. 3 is a block diagram of detection control in the first embodiment. FIGS. 4A and 4B are diagrams for describing a divided video count used in the control. FIG. 5 is a flowchart illustrating a control process of estimating fusion bonding of toner.

Referring to FIG. 5, in Step S101, a central processing unit (CPU) 99 (an execution unit) in the apparatus receives a print job transmitted from a user.

In Step S102, the CPU 99 (the execution unit) measures a ratio of an image to the image signal (hereinafter referred to as a video count) in response to the image signal to be printed out with a video count calculator 100 (a counting unit and a first counting unit).

In other words, the first counting unit counts an entire image ratio, which is the ratio of an image to the image signal corresponding to one entire image.

In the first embodiment, the video count calculator 100 (a second counting unit) divides one image into ten portions (B1 to B10) in a main scanning direction orthogonal to the direction in which the photoconductor moves, as illustrated by an image 1 in FIG. 4A and an image 2 in FIG. 4B.

The second counting unit counts a partial image ratio, which is the ratio of an image to the image signal corresponding to each portion resulting from the division. Each divided video count value resulting from the division in the main scanning direction is denoted by Bx (x=1 to 10) and an entire video count value is denoted by A.

In the case of an A4-size solid image (having an image ratio of 100%), the entire video count value is set to 528.

A more accurate result is produced with the increasing number of divided video counts in the main scanning direction. Specifically, the number of divided video counts is desirably 10 or more and is more desirably 32 or more.

Referring back to FIG. 5, in Step S103, the CPU 99 (the execution unit) calculates a fusion-bonding-of-toner index integrated value Rp with a parameter calculator 200. The CPU 99 (the execution unit) measures an charging time T for each job with a charging time measurer 102 and stores the measured charging time T. The fusion-bonding-of-toner index integrated value Rp is defined according to Equation 1:

Rp=Σ(α×T) (1)

where α denotes a fusion-bonding-of-toner index, A denotes the entire video count value, B denotes the divided video count value, and T denotes the charging time (sec).

Although the charging time T is used in the first embodiment, a rotation time in which the photoconductor rotates during a job may be used.

The fusion-bonding-of-toner index integrated value Rp is calculated by integrating the values from a time when use of the photoconductor or the unit is started to a time when maintenance is performed. The fusion-bonding-of-toner index integrated value Rp is substantially equal to the height (μm) of the fusion bonding of toner on the surface of the photoconductor drum.

The sum of the values calculated by multiplying the fusion-bonding-of-toner index a by the charging time T is considered to represent the fusion bonding of toner.

The fusion-bonding-of-toner index a is associated with combinations of the entire image ratio and the partial image ratio, as indicated in Table 1.

Since the ease of the fusion bonding of toner is varied with the usage environment, the table of the fusion-bonding-of-toner index a is varied with the usage environment. Accordingly, multiple tables corresponding to temperatures and humidities may be prepared and a calculation equation may be determined in advance so as to interpolate the temperatures and humidities between the multiple tables through calculation.

The fusion-bonding-of-toner index a is capable of being calculated based on the entire video count value A, the divided video count value B, and the results of detection of the temperature and humidity detected with an environment sensor 101.

Alternatively, a table may be used, in which the fusion-bonding-of-toner index a is varied depending on the charging roller and the cleaning blade around the photoconductor drum and the toner that is used.

In usage environment at a high temperature and a high humidity (30° C. and 80%), Table 1 is used.

TABLE 1

| VALUE OF α × | | A | | | | | | |
|---|---|---|---|---|---|---|---|---|
| 10\hat{ }−4 | | 0 | 52.8 | 105.6 | 211.2 | 316.8 | 422.4 | 528 |
| B | 0 | 0.0 | 0.0 | 5.0 | 10.0 | 15.0 | 20.0 | 25.0 |
| | 11.7 | 0.0 | 0.0 | 2.5 | 5.0 | 7.5 | 10.0 | 12.5 |
| | 23.4 | 0.0 | 0.0 | 1.3 | 2.5 | 3.8 | 5.0 | 6.3 |
| | 35.1 | 0.0 | 0.0 | 0.6 | 1.3 | 1.9 | 2.5 | 3.1 |
| | 46.8 | 0.0 | 0.0 | 0.3 | 0.6 | 0.9 | 1.3 | 1.6 |
| | 52.8 | 0.0 | 0.0 | 0.2 | 0.3 | 0.5 | 0.6 | 0.8 |

As apparent from Table 1, since the fusion-bonding-of-toner index a is increased with the increasing entire video count value, the fusion bonding of toner is easy to occur.

Table 1 indicates that, since the fusion-bonding-of-toner index a is decreased with the increasing divided video count value Bx even if the entire video count value A is high, the fusion bonding of toner is difficult to occur.

In contrast, Table 1 indicates that, since the fusion-bonding-of-toner index a is increased with the decreasing divided video count value Bx even if the entire video count value A is high, the fusion bonding of toner is easy to occur.

This is because, when the entire video count value A is high and the divided video count value Bx is low, the capacity of removing adhesions on the surface of the photoconductor drum may be reduced due to depletion of the toner in a nip portion of a cleaning blade 7. The cleaning blades 7Y, 7M, 7C, and 7K are collectively referred to as the cleaning blade 7.

In contrast, the toner-derived component caused by the large amount of consumption of toner may be easily isolated on the surface of the photoconductor.

Accordingly, it is supposed that the fusion bonding of toner grows because the growth exceeds the removal.

In usage environment at a normal temperature and humidity (20° C. and 50%), Table 2 is used. Table 2 indicates that the fusion-bonding-of-toner index a is lower than that in the usage environment at a high temperature and a high humidity (30° C. and 80%). This is because the toner is less affected by heat and the fusion bonding of toner is difficult to occur.

TABLE 2

| | | A | | | | | | |
|---|---|---|---|---|---|---|---|---|
| VALUE OF α × | | 0 | 10 | 20 | 40 | 60 | 80 | 100 |
| 10\hat{ }−4 | | 0 | 52.8 | 105.6 | 211.2 | 316.8 | 422.4 | 528 |
| B | 0 | 0.0 | 0.0 | 1.3 | 2.5 | 2.5 | 3.3 | 3.6 |
| | 11.7 | 0.0 | 0.0 | 0.6 | 1.3 | 1.3 | 1.7 | 1.8 |
| | 23.4 | 0.0 | 0.0 | 0.3 | 0.6 | 0.6 | 0.8 | 0.9 |
| | 35.1 | 0.0 | 0.0 | 0.0 | 0.3 | 0.3 | 0.4 | 0.4 |
| | 46.8 | 0.0 | 0.0 | 0.0 | 0.0 | 0.2 | 0.2 | 0.2 |
| | 52.8 | 0.0 | 0.0 | 0.0 | 0.0 | 0.0 | 0.1 | 0.1 |

As described above, the CPU 99 (the execution unit) divides the fusion-bonding-of-toner index integrated value Rp into 10 values (Rpx (x=1 to 10)) and performs the integration of the usage environment, the toner consumption amounts A and B to be used, and the charging time in the main scanning direction.

The CPU 99 performs the calculation using linear interpolation for portions between the environment sections. In the calculation, the horizontal axis represents the amount of moisture (the absolute amount of moisture). However, the horizontal axis may represent the temperature depending on the used configuration or the toner.

Referring back to FIG. 5, in Step S104, the CPU 99 (the execution unit) determines whether the fusion-bonding-of-toner index integrated value Rpx (x=1 to 10) exceeds a predetermined threshold value Z after the calculation of the parameter of each job.

The threshold value Z means a threshold value at which a normal image is displayed regardless of the presence of the fusion bonding of toner. The threshold value Z is set to six (Z=6) in the first embodiment, although the threshold value Z may be varied depending on the usage environment.

If the CPU 99 (the execution unit) determines in Step S104 that Rpx>Z=6 at a specific portion, in Step S105, the CPU 99 (the execution unit) displays information about maintenance. The maintenance is exemplified by cleaning or replacement.

The execution unit displays the information about maintenance in a display unit 300 to indicate a guide to the maintenance of the image forming unit to the user or a service man.

The execution unit may display 100% when the fusion-bonding-of-toner index integrated value Rpx=6 is set as the life and may display 50% when Rpx=3 is set as the life to use the fusion-bonding-of-toner index integrated value Rpx as a life estimation counter.

After the maintenance is performed, the execution unit resets the fusion-bonding-of-toner index integrated value Rpx (x=1 to 10) to zero.

If the CPU 99 (the execution unit) determines in Step S104 that Rpx<Z at a specific portion, the process goes back to Step S101 to wait for the next job.

When the image formation is repeated using the entire image ratio and the partial image ratio that are fixed by the execution unit, the magnitude relationship of X described in (1) and (2) is established. Here, X denotes the number of image formations from the time when use of the photoconductor or the unit is started to the time when the display is performed in the display unit.

(1) X when the entire image ratio has a first value and the partial image ratio has a second value is greater than X when the entire image ratio has a value smaller than the first value and the partial image ratio has a value smaller than the second value.

(2) X when the partial image ratio has a third value and the entire image ratio has a fourth value is smaller than X when the partial image ratio has a value smaller than the third value and the entire image ratio has a value smaller than the fourth value.

The condition of the image formation to be repeated in the comparison (1) is made equal to that in the comparison (2). The condition of the image formation to be repeated is, for example, an image formation mode, such as continuous image formation or intermittent image formation, the voltage set at the photoconductor, or a process condition, such as development bias or transfer bias. The use of the same image formation condition causes the number of image formations to be associated with a charging cumulative time or a cumulative rotation time of the photoconductor, thus facilitating the comparisons.

### 4. Result of Comparative Verification

Conditions and their results when sheet supply is continued in the environment at a high temperature and a high humidity (30° C. and 80%) using the images in FIG. 4A and FIG. 4B, which have the entire image ratio of 20% (A=105.6), in the control described above are indicated in Table 3.

TABLE 3

| EVALUATION CONDITION | | | | | | |
|---|---|---|---|---|---|---|
| | MAIN | | | | RESULT | |
| IMAGE | SCANNING | | | TIME | | IMAGE |
| TYPE | POSITION | A | B | (min) | Rp | DETERMINATION |
| IMAGE | B5 | 105.6 | 0 | 235 | 6 | OVEREXPOSURE |
| 1 | | | | | | |
| IMAGE | B1 | 105.6 | 11.7 | 235 | 3 | IMAGE OK |
| 2 | | | | | | |

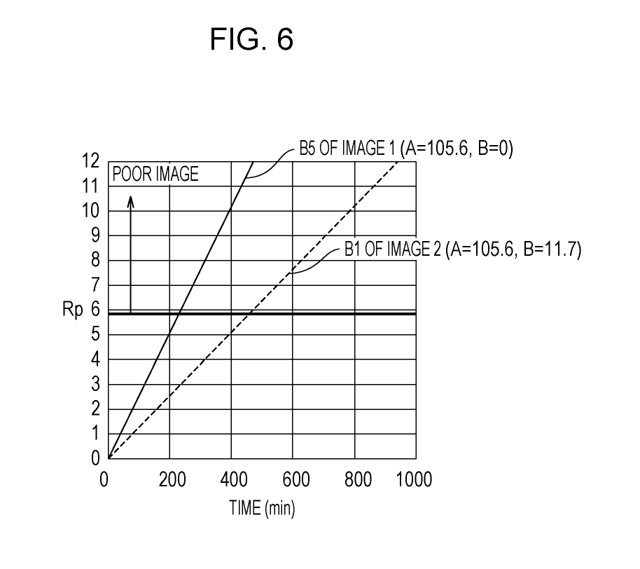

The duration transitions of the fusion-bonding-of-toner index integrated value Rpx at a portion B5 (A=105.6 and B=0) having the lowest evaluation values of the image 1 and at a portion B1 (A=105.6 and B=11.7) having the lowest evaluation value of the image 2 are illustrated in FIG. 6.

At the portion B5 of the image 1, the fusion-bonding-of-toner index integrated value Rp exceeds six (Rp=6) when the sheet supply is continued for about 235 min to cause a poor image. The fusion bonding of toner occurs on the surface of the photoconductor.

At the portion B1 of the image 2, the fusion-bonding-of-toner index integrated value Rp is equal to three (Rp=3) when the sheet supply is continued for about 235 min not to cause a poor image.

Since the fusion bonding of toner does not grow so much although the fusion bonding of toner occurs on the surface of the photoconductor, the fusion bonding of toner is not visible in the image. Accordingly, the determination of the fusion bonding of toner only from the amount of consumption of toner (the entire video count) used in the related art may produce a result of determination of a poor image regardless of no problem in the image 2, thus causing the display of the information about maintenance or the life determination.

As described above, it is possible to accurately determining the fusion bonding of toner in the first embodiment.

### Second Embodiment

A case will now be described in which a recovery mode is performed in order to increase the life of the image forming apparatus. Since the determination only from the entire video count value A, as in the related art, causes the recovery mode to be performed frequently, the productivity is reduced. Accordingly, it is important to set an appropriate frequency, as in a second embodiment.

### 5. Description of how to Control Recovery Mode of Fusion Bonding of Toner

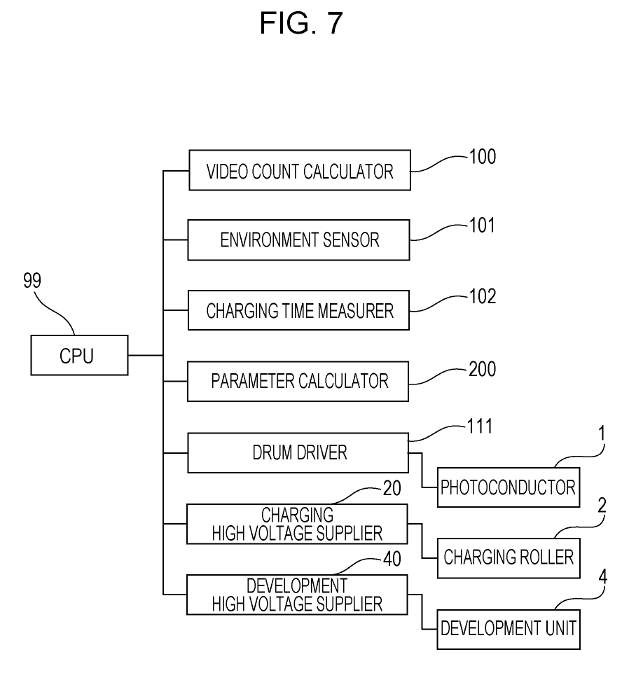

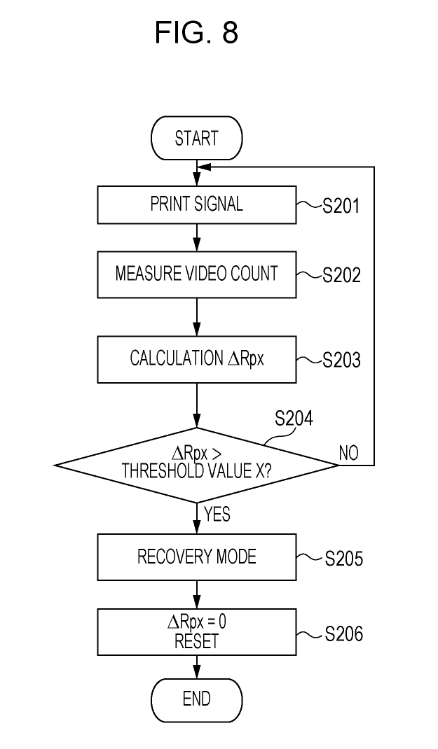

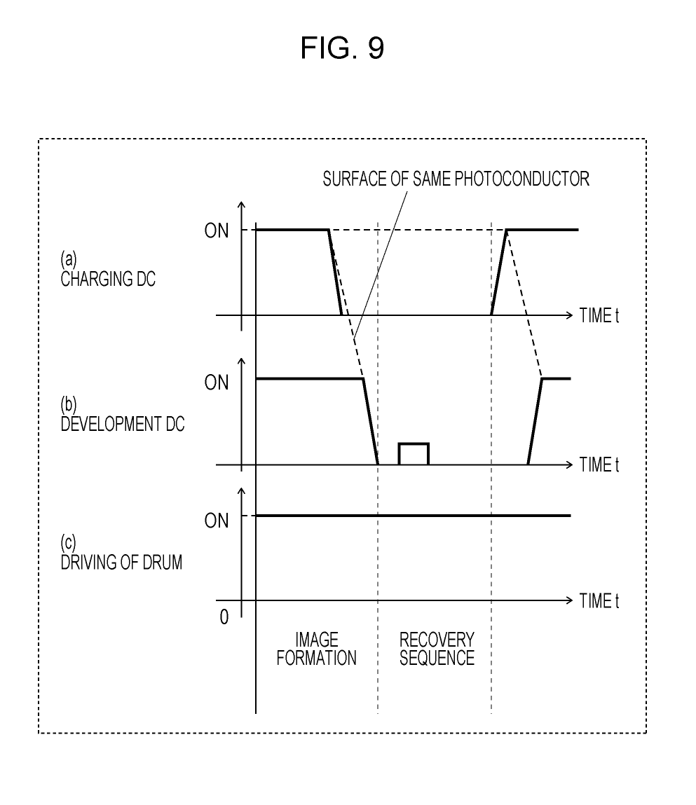

FIG. 7 is a block diagram of recovery mode control in the second embodiment. FIG. 8 is a flowchart illustrating a process of controlling the recovery mode of the fusion bonding of toner. FIG. 9 is a timing chart illustrating how the recovery mode of the fusion bonding of toner is controlled.

Referring to FIG. 8, in Step S201, the CPU 99 (the execution unit) receives a print job and, in Step S202, the CPU 99 (the execution unit) measures the video count, as in the first embodiment.

In Step S203, the CPU 99 (the execution unit) calculates the difference ΔRpx from the previous recovery mode to the next recovery mode, in addition to the fusion-bonding-of-toner index integrated value Rpx of the image forming apparatus.

The CPU 99 (the execution unit) divides the fusion-bonding-of-toner index integrated value Rp into 10 values (ΔRpx (x=1 to 10)) and performs the integration of the usage environment, the toner consumption amounts A and B to be used, and the charging time in the main scanning direction.

In Step S204, the CPU 99 (the execution unit) determines whether the difference ΔRpx exceeds a predetermined threshold value X. The threshold value X indicates the interval at which the recovery mode is performed.

The threshold value X is set to 0.03 (X=0.03) in the second embodiment although the threshold value X may be varied depending on the usage environment. In order to keep the balance between the growth and the removal, the CPU 99 (the execution unit) performs the recovery mode if the difference ΔRpx is incremented by 0.03.

If the CPU 99 (the execution unit) determines in Step S204 that the difference ΔRpx does not exceed the threshold value X, the process goes back to Step S201 to wait for the next print job.

As illustrated in FIG. 7, during the image formation, charging direct-current voltage is applied from a charging high voltage supplier 20 to a charging roller 2 and development direct-current voltage is applied from a development high voltage supplier 40 to a development unit 4 to drive a photoconductor 1 from a drum driver 111.

If the CPU 99 (the execution unit) determines in Step S204 that the integrated difference ΔRpx (x=1 to 10) exceeds the threshold value X, in Step S205, the CPU 99 (the execution unit) performs the recovery mode.

The execution unit rises the charging direct-current voltage and the development direct-current voltage to terminate the image formation in order to perform the recovery mode during a period excepting an image formation period.

Then, the execution unit forms a toner image on the photoconductor by rising the development direct-current voltage by about −100 V to supply the toner to the cleaning blade.

The execution unit drives only the photoconductor in this state to clear the fusion bonding of toner on the photoconductor drum. Here, the execution unit desirably causes the charging roller not to discharge. This is because the discharge may grow the fusion bonding of toner.

In addition, the execution unit desirably supplies the toner to the cleaning blade 7 in order to stabilize the behavior of the cleaning blade 7. However, since the supply of the toner in the charging state leads the growth of the fusion bonding of toner, the supply of the toner is desirably performed in a non-charging state immediately before the driving of the photoconductor drum. The execution unit performs the driving of the photoconductor drum in the non-charging state for one minute.

Upon reception of a signal to instruct the image formation, the execution unit rises the charging direct-current voltage and the development direct-current voltage for the next image formation.

Referring back to FIG. 8, after the recovery mode is performed, in Step S206, the CPU 99 (the execution unit) resets the difference ΔRpx (x=1 to 10) to zero (0).

If the CPU 99 (the execution unit) determines in Step S204 that the difference ΔRpx does not exceeds the threshold value X, the process goes back to Step S201 to wait for the next job. When the recovery mode is performed in order to calculate the fusion-bonding-of-toner index integrated value Rp, the execution unit decreases the fusion-bonding-of-toner index integrated value Rp in accordance with the fusion-bonding-of-toner index integrated value Rp.

In the case of idle rotation for one minute in the second embodiment, the execution unit decreases the fusion-bonding-of-toner index integrated value Rp by 0.3 when Rp=1, decreases the fusion-bonding-of-toner index integrated value Rp by 1.1 when Rp=3, and decreases the fusion-bonding-of-toner index integrated value Rp by 1.5 when Rp=5 to correct the fusion-bonding-of-toner index integrated value Rp. The execution unit calculates the fusion-bonding-of-toner index integrated value Rp using the linear interpolation.

The amount by which the fusion-bonding-of-toner index integrated value Rpx is decreased is not limited to the above ones and may be varied depending on the usage configuration, the toner, or the usage environment.

In other words, the execution unit performs the recovery mode in which the toner image is formed on the photoconductor based on the entire image ratio and the partial image ratio, which are counted by the counting unit, during the period excepting the image formation period to supply the toner to the cleaning blade, thus rotating the photoconductor.

When the image formation is repeated using the entire image ratio and the partial image ratio that are fixed by the execution unit, the magnitude relationship of X described in (1) and (2) is established. Here, X denotes the number of image formations from one recovery mode to the next recovery mode.

(1) X when the entire image ratio has a first value and the partial image ratio has a second value is greater than X when the entire image ratio has a value smaller than the first value and the partial image ratio has a value smaller than the second value.

(2) X when the partial image ratio has a third value and the entire image ratio has a fourth value is smaller than X when the partial image ratio has a value smaller than the third value and the entire image ratio has a value smaller than the fourth value.

The condition of the image formation to be repeated in the comparison (1) is made equal to that in the comparison (2). The condition of the image formation to be repeated is, for example, an image formation mode, such as continuous image formation or intermittent image formation, the voltage set at the photoconductor, or a process condition, such as development bias or transfer bias. The use of the same image formation condition causes the number of image formations to be associated with a charging cumulative time or a cumulative rotation time of the photoconductor, thus facilitating the comparisons.

### 6. Result of Comparative Verification

Conditions and their results when sheet supply is continued in the environment at a high temperature and a high humidity (30° C. and 80%) using the image in FIG. 4A, which has the entire image ratio of 20% (A=105.6), when the recovery mode described above is performed, are indicated in Table 4.

TABLE 4

| EVALUATION CONDITION | | | | | | | |
|---|---|---|---|---|---|---|---|
| | MAIN | | | | | RESULT | |
| IMAGE | SCANNING | | | RECOVERY | TIME | Rp | IMAGE |
| TYPE | POSITION | A | B | MODE | (min) | (μm) | DETERMINATION |
| IMAGE 1 | B5 | 105.6 | 11.7 | NOT APPLIED | 235 | 6 | OVEREXPOSURE |
| | | | | (SEQUENCE | | | |
| | | | | A) | | | |
| IMAGE 1 | B5 | 105.6 | 11.7 | APPLIED | 235 | 3 | IMAGE OK |
| | | | | (SEQUENCE | | | |
| | | | | B) | | | |

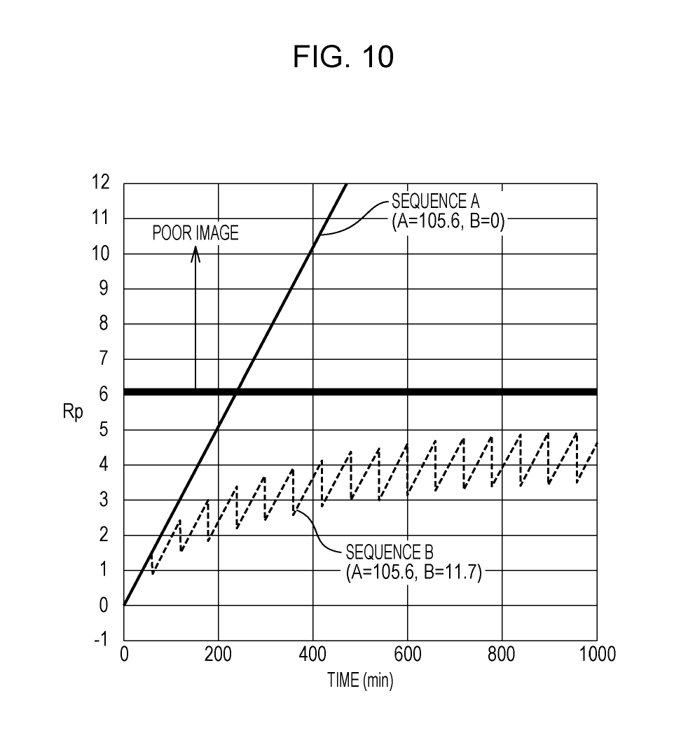

The transition of the fusion-bonding-of-toner index integrated value Rpx (x=5) when the evaluation is performed based on whether the recovery mode is applied or not is illustrated in FIG. 10. A case in which the recovery mode is not performed is referred to as a sequence A and a case in which the recovery mode is performed is referred to as a sequence B.

In the sequence A in which the recovery mode is not applied, the fusion-bonding-of-toner index integrated value Rp5 (x=5) exceeds six (Rp5=6) when the sheet supply is continued for about 235 min to cause a poor image.

The fusion bonding of toner occurs on the surface of the photoconductor.

In the sequence B in which the recovery mode is applied, the fusion-bonding-of-toner index integrated value Rp5 is equal to three (Rp5=3) when the sheet supply is continued for about 235 min not to cause a poor image.

Since the fusion bonding of toner does not grow so much although the fusion bonding of toner occurs on the surface of the photoconductor, the fusion bonding of toner is not visible in the image.

Performing the recovery mode enables the growth of the fusion bonding of toner to be suppressed for a long time.

As described above, the fusion bonding of toner is capable of being accurately determined to perform the recovery mode in the second embodiment.

Accordingly, it is possible to appropriately remove the fusion bonding of toner without excessively reducing the productivity.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-181953 filed Sep. 22, 2017 and No. 2018-134290 filed Jul. 17, 2018, which are hereby incorporated by reference herein in their entirety.

What is claimed is:

1. An image forming apparatus comprising:
a movable photoconductor;
a charging member configured to charge the photoconductor,
an exposure unit configured to perform image exposure based on an image signal to the charged photoconductor to form an electrostatic latent image;
an image forming unit configured to cause toner to adhere to the electrostatic latent image formed on the photoconductor to form a toner image and, then, to transfer the toner image on a recording material to form an image;
a counting unit including a first counting unit and a second counting unit, the first counting unit counting an entire image ratio, which is a ratio of an image to the image signal corresponding to one entire image, the second counting unit counting a partial image ratio, which is a ratio of an image to the image signal corresponding to each portion resulting from division of one entire image in a main scanning direction orthogonal to a direction in which the photoconductor moves;
a display unit configured to display information about maintenance of the photoconductor or information about maintenance of a unit that includes the photoconductor and that is removable from a main body of the image forming apparatus; and
an execution unit configured to perform the display in the display unit based on the entire image ratio and the partial image ratio, which are counted by the counting unit, and to perform the display in the display unit so that (1) X when image formation is repeated in a condition in which the entire image ratio has a first value and the partial image ratio has a second value is greater than X when the image formation is repeated in a condition in which the entire image ratio has a value smaller than the first value and the partial image ratio has a value smaller than the second value and (2) X when image formation is repeated in a condition in which the partial image ratio has a third value and the entire image ratio has a fourth value is smaller than X when the image formation is repeated in a condition in which the partial image ratio has a value smaller than the third value and the entire image ratio has a value smaller than the fourth value, X denoting a number of image formations from a time when use of the photoconductor or the unit is started to a time when the display is performed in the display unit.

2. The image forming apparatus according to claim 1,
wherein the execution unit performs the display in the display unit based on an integrated value resulting from integration over a plurality of image formations of a value calculated by multiplying an index associated with a combination of the entire image ratio and the partial image ratio in one image formation by a time related to each image formation.

3. The image forming apparatus according to claim 2,
wherein the time related to each image formation is a time when voltage is applied to the charging member in each image formation.

4. The image forming apparatus according to claim 2,
wherein the time related to each image formation is a time when the photoconductor rotates in each image formation.

5. The image forming apparatus according to claim 1,
wherein a number of portions resulting from division of one entire image is 10 or more.

6. The image forming apparatus according to claim 1,
wherein a number of portions resulting from division of one entire image is 32 or more.

7. The image forming apparatus according to claim 2, further comprising:
a sensor configured to detect a temperature and a humidity around the image forming apparatus,
wherein the execution unit varies the index based on a result of the detection by the sensor.

8. An image forming apparatus comprising:
a movable photoconductor;
a charging member configured to charge the photoconductor;
an exposure unit configured to perform image exposure based on an image signal to the charged photoconductor to form an electrostatic latent image;
an image forming unit configured to cause toner to adhere to the electrostatic latent image formed on the photoconductor to form a toner image and, then, to transfer the toner image on a recording material to form an image;
a counting unit including a first counting unit and a second counting unit, the first counting unit counting an entire image ratio, which is a ratio of an image to the image signal corresponding to one entire image, the second counting unit counting a partial image ratio, which is a ratio of an image to the image signal corresponding to each portion resulting from division of one entire image in a main scanning direction orthogonal to a direction in which the photoconductor moves; and
an execution unit configured to perform a recovery mode in which a toner image is formed on the photoconductor based on the entire image ratio and the partial image ratio, which are counted by the counting unit, during a period excepting an image formation period to supply toner to a cleaning blade, thus rotating the photoconductor and to perform the recovery mode so that (1) X when image formation is repeated in a condition in which the entire image ratio has a first value and the partial image ratio has a second value is greater than X when the image formation is repeated in a condition in which the entire image ratio has a value smaller than the first value and the partial image ratio has a value smaller than the second value and (2) X when image formation is repeated in a condition in which the partial image ratio has a third value and the entire image ratio has a fourth value is smaller than X when the image formation is repeated in a condition in which the partial image ratio has a value smaller than the third value and the entire image ratio has a value smaller than the fourth value, X denoting a number of image formations from a time when one recovery mode is performed to a time when the next recovery mode is performed.

9. The image forming apparatus according to claim 8,
wherein the execution unit performs the recovery mode based on an integrated value resulting from integration over a plurality of image formations of a value calculated by multiplying an index associated with a combination of the entire image ratio and the partial image ratio in one image formation by a time related to each image formation.

10. The image forming apparatus according to claim 9,
wherein the time related to each image formation is a time when voltage is applied to the charging member in each image formation.

11. The image forming apparatus according to claim 9,
wherein the time related to each image formation is a time when the photoconductor rotates in each image formation.

12. The image forming apparatus according to claim 8,
wherein a number of portions resulting from division of one entire image is 10 or more.
